(19) United States
(12) Patent Application Publication
(10) Pub. No.: US 2016/0083939 A1
(43) Pub. Date: Mar. 24, 2016

(54) "Doogie Box" Water Reclamation and Reuse System

(71) Applicant: Daniel J Dugan, JR., Wilmington, NC (US)

(72) Inventor: Daniel J Dugan, JR., Wilmington, NC (US)

(21) Appl. No.: 14/492,475

(22) Filed: Sep. 22, 2014

(51) Int. Cl. E03B 11/02; B01D 21/00; A01G 25/00; F16K 24/04

(52) U.S. Cl. CPC E03B 11/02; F16K 24/04; B01D 21/0042; A01G 25/00

(57) ABSTRACT

This invention harvests abundant, highly usable washing machine rinse cycle water for irrigation and other uses. This is accomplished using two separate devices working together; it is comprised of a valve assembly (FIG. 2B), for diverting this rinse water to a collector and the collector (10) which improves the quality of the water, then distributes it. By closing a single valve (7) during the rinse cycle, the user is effectively watering the landscaping. The rinse water is regenerated during normal household washing so it is not dependent on rain. It does not use power nor does it depend on filters or storing water. It reduces the amount of city water required as well as reducing the volume of waste water generated.

### REFERENCES CITED

U.S. Patent Documents

| | | |
|---|---|---|
| 6,969,460 | Olson | 210/130 |
| 7,267,235 | Sharir | 210/413 |
| 8,201,581 | George | 137/876 |
| 8,372,274 | Early, et al | 210/86 |
| 7,040,340 | Jeltsch, et al | 137/255 |
| 5,573,677 | Dembrosky | 210/764 |
| 5,192,426 | DeCoster et al | 210/117 |

### BACKGROUND OF THE INVENTION

I am a pipefitter by trade and I began to start thinking about ways to save water about twenty years ago. I made some early prototypes of water harvesters, but water was viewed as cheap and plentiful so I shelved the idea. When I moved here in 2006, North Carolina was in a drought condition and I made some prototypes using clear plastic boxes and buckets to observe the hydraulic action. Later, when I heard on the news that there were extraordinary droughts in Texas and elsewhere, I thought I might try again in earnest. This invention is the result.

The greywater harvesting systems that I had seen contained good ideas, such as using greywater to flush toilets, but there are problems inherent in dual water supply fixtures like backflow protection and filter maintenance. This invention does not need maintenance, use power, filters, large tanks or extra pumps as in a car wash. It is not dependent on rain nor does it store water, so it does not attract vermin or foster stagnant water type growth as in a rain barrel. The only moving parts are the valves.

### ADVANTAGES

The benefit to society by the use of The “Doogie Box” Water Reclamation and Reuse System is significant. The Box was created to help address the need for more effective water management. I have seen no other system that attempts to harvest only abundant, high quality washing machine rinse water, which allows a simple system to harvest and distribute this water for irrigation. The benefit to the individual in society is to reduce his use of city water, reduce the amount of wastewater he sends to the treatment plant and lower the cost of his monthly utility bills. The benefit to society as a whole is the cumulative benefit that reduces the demands on overtaxed utilities. The benefit to our habitat is we are supporting the growth of green plants, which supports the water cycle and the regeneration of aquifers. The root systems of these plants help to anchor topsoil.

### BRIEF SUMMARY OF THE INVENTION

This invention is designed to harvest the rinse water from a clothes washing machine or other washing machine in a new way for use in irrigation or other washing. It consists of two main elements working together; a diverter assembly and a collector that distributes the harvested water. The diverter assembly is comprised of a plumbing tee that is installed on the top of the standpipe that accepts the washer discharge. The diverter valve is installed on the downstream port of the tee. During the rinse cycle the valve is closed, redirecting the waste/rinse water to piping through the wall, outside to a collector. This collector will handle the discharge from a typical domestic washer rinse cycle and allow the collector to process the water. The collector uses two baffles to trap the soap suds which float, the small amount of solids which sink, and uses only the middle part of the water column for irrigation or other uses. The water is processed by the collector, which may be nested in a planter box which waters the foliage in the planter box using a gravity distribution header. The excess water then seeps through the planter box to an outlet at the bottom which is used to water a lawn through leach field piping, drip irrigation or other uses. The foliage in the planter box, as well as the green grass of the lawn, supports a tiered collection of plants which support the water cycle without using any additional city water as well as reducing the amount of waste water to the city sewer.

### DETAILED DESCRIPTION OF THE INVENTION

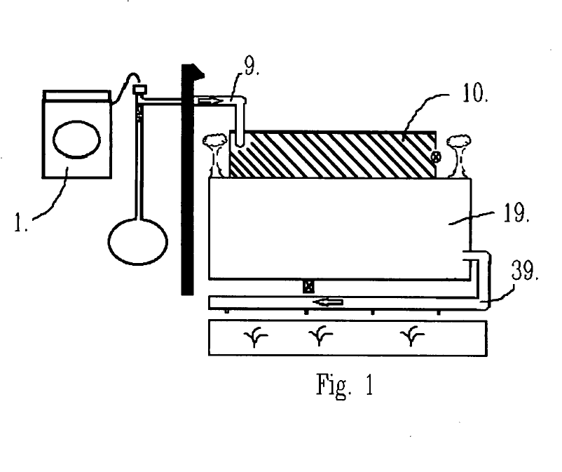

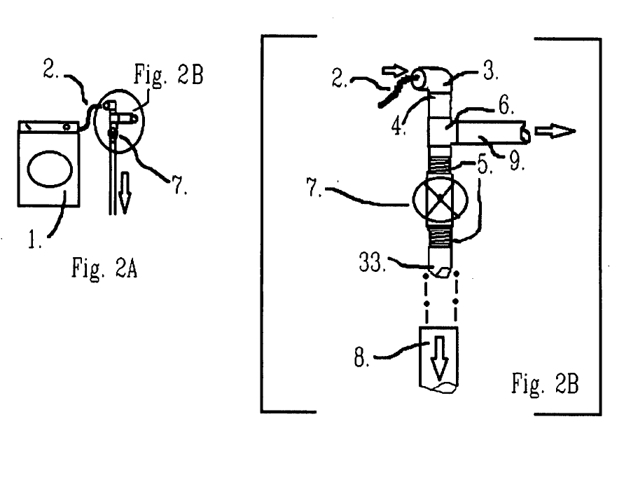

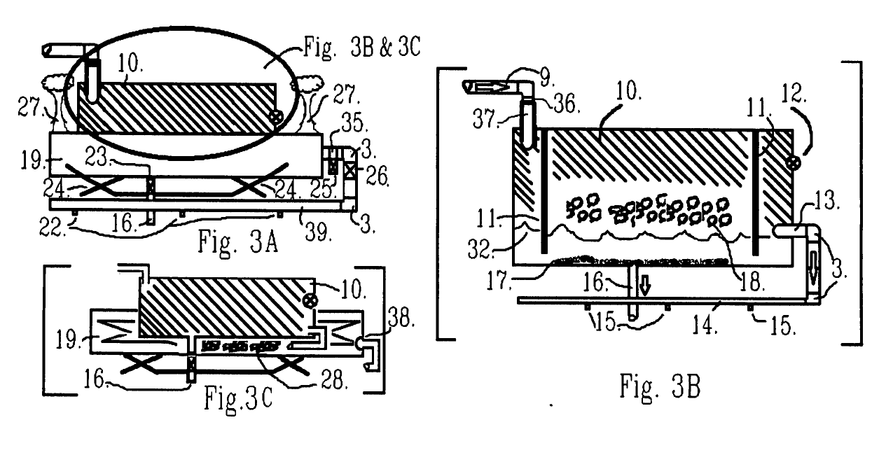

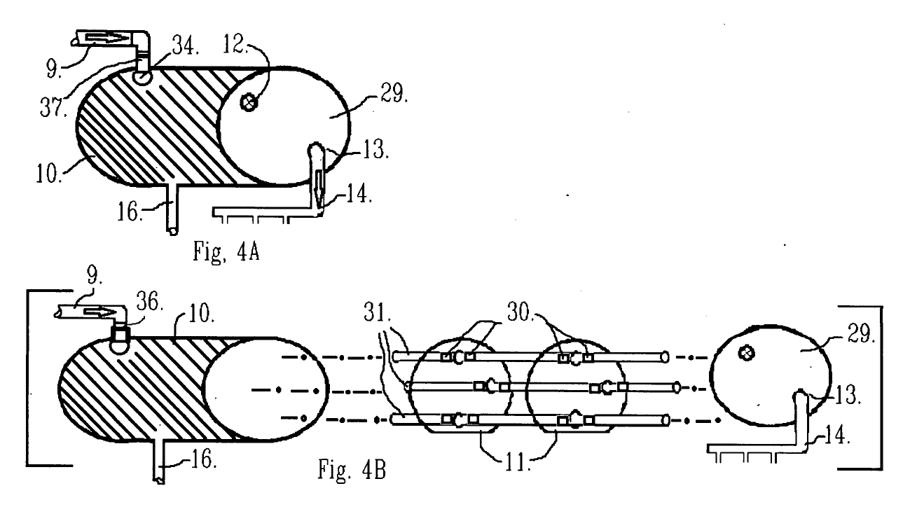

(All piping and fittings are standard, schedule 40, PVC unless otherwise noted.) The Invention consists of a 1″ plumbing tee (FIG. 2A #6) to divert water from the rinse cycle of a washing machine (FIG. 2 #1) to a collector (FIG. 3-4A #10) for reuse in irrigation instead of the city sewer. A standard clothes washing machine discharge hose (FIG. 2, 2A #2) has an outside diameter equal to that of a standard schedule 40 - 1″ PVC pipe. A brass 1 ¼″ gate valve (FIG. 2, 2A #7), whose handle faces the user, is used to provide a full port for the 1″ pipe for discharging wash water to the standpipe (FIG. 2A #8) when in the open position. A manual gate valve is used because it is much cheaper than an electrical valve and does not supply the unwanted leverage of a ball valve on the piping. (If a domestic dishwasher is used, the discharge hose is about ½″.) The bottom of the gate valve is attached to a 1″ adapter (FIG. 2A #5), then to a length of 1″ rubber hose (FIG. 2A #33) for easy insertion into the standpipe. The total length of the adapter and hose create a tailpiece 5″ long. The tailpiece is inserted into the top of the 2″ residential indirect waste (FIG. 2A #8), washing machine standpipe. On top of the run, or straight line through the tee, is a 1″ PVC elbow (FIG. 2A # 3), which accepts the washer discharge hose (2) and faces the washer. The bull, or side port of the tee (FIG. 2A # 6) faces the outside wall and is connected to a 1″ PVC pipe (FIG. 2A # 9) which channels the water outside, to the collector, when the gate valve is closed by the user.

Outside a 30 gallon horizontal drum (FIGS. 3A-4B #10) with a removable lid (FIG. 4B #29) may be used for a collector. It accepts the rinse water through an 1 ½″ hole (FIGS. 4A,4B #34) drilled in the top, outside perimeter of the drum, near the sealed side of the drum, opposite the removable lid. The inlet pipe to the drum (FIG. 4A,4B #37) is increased to 1 ½″ pipe to facilitate the flow of water into the drum. The hole is ⅛″ oversized to allow for venting. The top bung hole on the collector's lid (FIG. 4 #12) is a vent. The removable lid allows for the insertion of a baffle assembly (FIG. 4B # 11, 30, 31). The baffle assembly consists of two flat, round, plastic baffles made from ¼″ plexiglass (FIG. 4B #11). The diameter of the baffles equals the diameter of the inside of the drum and they fit snugly inside and are caulked to the inside of the drum. They are connected by three, ¾″ PVC pipes (FIG. 4B #31) that pass through the baffles creating a triangular pattern, with slip couplings (FIG. 4B #30) on the pipes for the baffles to rest against. The vertical baffles face each other and each is located 4″ from its respective end of the drum. The bottom 2″ of the baffles are removed to permit restricted flow. The restricted flow allows the drum time to do its job; which is to catch floating suds (FIG. 3A #18) between the baffles and settle any remaining solids (FIG. 3B #17) allowing the cleanest, highly usable residual water (FIG. 3B #32) for irrigation, or other uses like car washing, to emerge from the bottom bung hole (FIG. 3B #13) on the lid side of the collector. The harvested rinse water is of high quality to begin with because it excludes wash water which may contain soap, bleach or other contaminants. Using dryer sheets keeps fabric softener out of the rinse water. There is a ¾″ cleanout PVC pipe (FIG. 3A-4B #16) on the bottom of the collector which extends through the planter box to a ¾″ plastic, cleanout ball valve (FIG. 3A #23). Our 30 gallon collector drum nests inside a planter box (FIG. 3A, 3C #19) made from a 55 gallon sealed top drum, cut in half lengthwise, with one of the bung holes (FIG. 3C #38) in each half. The planter sits on a stand (FIG. 3A #24) that is made of pressure treated 2×4's assembled in an “X” pattern for economy or an industrial drum holder may be used. The planter bedding (FIG. 3C #28) is a mix of coarse gravel for drainage on the bottom, backfilled with planter medium such as soil. The collector is placed on top of the gravel, then it is back filled with soil for landscaping plants (FIG. 3A #27). The outlet bung hole of the collector is connected by ½″ PVC pipe (FIG. 3B #13) to an irrigation header (FIG. 3B #14), to ¼″ nozzles (FIG. 3A #15) that water the planter box. The gravel will allow the excess water to seep to the bottom of the planter box without drowning the planter box plants, through the planter box to the bung hole (FIG. 3C #38) which serves as an outlet supplying the external irrigation distribution. The bung hole on the end of the 55 g. planter box (FIG. 3C #38) is connected first to a hose bibb tee (FIG. 3A #35) for auxiliary use, then to a ¾″ PVC pipe (FIG. 3A #39) which supplies landscaping drip irrigation (FIG. 3A #22). A ¾″ PVC ball valve (FIG. 3A #26) placed after the hose bibb tee diverts water to the hose bibb (FIG. 3A #25) when in the closed position.

The drum has a cleanout, which is a ¾″ PVC pipe (FIG. 3A-4B #16) which drains the bottom of the 30 g. tank by extending through the planter box to a ¾″ PVC ball valve (FIG. 3A #23) which purges the tank if desired.

### BRIEF DESCRIPTION OF THE SEVERAL VIEWS OF THE DRAWINGS

The first drawing, 1/4, is a complete depiction of the entire system for the purpose of inclusion on the front page of the patent application publication and patent as the illustration of the invention.

In the second drawing, 2/4, FIG. 2A is designed to show the location of the directional valve and FIG. 2B shows an exploded view of the valve assembly.

In the third drawing, 3/4, FIG. 3A shows the drum assembly housed in a planter box with FIG. 3B showing an exploded view of the drum assembly and the water flow and relationship to the irrigation. FIG. 3C shows and exploded view of the planter box.

The fourth drawing, 4/4, shows FIG. 4A, the collector and an exploded view of the drum assembly FIG. 4B.

### PARTS LIST

| | |
|---|---|
| 1. washing machine | FIG. 2A |
| 2. washer water discharge hose | FIG. 2A, 2B |
| 3. plumbing ell | FIG. 2A-4C |
| 5. glue × screw m. adapter 1-1¼″ | FIG. 2B |
| 6. diverter tee | FIG. 2B |
| 7. 1¼″ gate valve FPT | FIG. 2A, 2B |
| 8. 2″ waste standpipe | FIG. 2B |
| 9. diverter pipe to drum | FIG. 2A-4C |
| 10. collector (30 g drum) | FIG. 2A-4C |
| 11. baffles | FIG. 3B, 4B |
| 12. 2″ vent | FIG. 3A-4A |
| 13. ½″ drum outlet | FIG. 3B-4B |
| 14. ½″ drum outlet header | FIG. 3B-4B |
| 15. ¼″ drip irrigation ports | FIG. 3B |
| 16. ¾″ clean out | FIG. 3A-4B |
| 17. settled solids | FIG. 3B |
| 18. soap suds | FIG. 3B |
| 19. planter box | FIG. 3A, 3C |
| 22. ¼″ drip irrigation ports | FIG. 3A |
| 23. ¾″ ball valve | FIG. 3A |
| 24. planter support 2 × 4″ wood | FIG. 3A |
| 25. ½″ hose bibb | FIG. 3A |
| 26. ¾″ ball valve | FIG. 3A |
| 27. planter box plants | FIG. 3A |
| 28. gravel/soil | FIG. 3C |
| 29. removeable drum lid | FIG. 4A, 4B |
| 30. ¾″ slip couplings | FIG. 4B |
| 31. ¾″ PVC pipe supports | FIG. 4B |
| 32. harvested rinse water | FIG. 3B |
| 33. 1″ rubber hose tailpiece | FIG. 2B |
| 34. hole-drum inlet | FIG. 4A, 4B |
| 35. aux outlet tee | FIG. 3A |
| 36. 1 × 1¼″ adapter | FIG. 3B-4B |
| 37. 1½″ PVC drum inlet | FIG. 3B-4B |
| 38. planter box outlet | FIG. 3C |
| 39. ¾″ PVC irrigation distribution | FIG. 3A |

I claim:

1. A vessel with ports which accepts greywater discharge at a primary inlet port and allows said greywater discharge to pass through said vessel exiting through a primary discharge port to waste piping and may be redirected through a secondary discharge port for further use.

2. Said primary discharge port of claim 1 which terminates in a primary valve which allows the flow of said greywater discharge through said primary discharge port to said waste piping when in the open position and redirects flow through said secondary discharge port when in the closed position.

3. A collector with ports which accepts said greywater discharge through a secondary inlet port directing flow through said collector exiting a tertiary discharge port for further use.

4. The collector in claim 3 with a baffle in said collector which redirects said greywater discharge.

5. The collector in claim 3 with a primary vent at said secondary inlet port.

6. The collector in claim 3 with a secondary vent at said tertiary discharge. port.

7. The collector in claim 3 with said tertiary discharge port supplying distribution piping.

8. A method of harvesting greywater comprising:
(a) providing said vessel with ports for accepting greywater discharge.
(b) providing said vessel with ports for allowing flow of greywater discharge.
(c) providing said primary valve for directing flow of greywater discharge.
(d) closing said primary valve to redirect the flow of greywater discharge.
(e) opening said primary valve to allow the flow of greywater discharge to said waste piping.
whereby said primary valve can be closed to redirect greywater discharge for further use and can be opened to allow flow of greywater discharge to said waste piping.
